(19) United States
(12) Patent Application Publication
(10) Pub. No.: US 2019/0202256 A1
(43) Pub. Date: Jul. 4, 2019

(54) Vehicle interior safe air management system

(71) Applicant: Jerry E. Brower, Vamcouver, WA (US)

(72) Inventor: Jerry E. Brower, Vamcouver, WA (US)

(21) Appl. No.: 15/859,739

(22) Filed: Jan. 2, 2018

(51) Int. Cl. B60H 1/00; B60H 3/00; B60H 1/24

(52) U.S. Cl. CPC B60H 1/008; B60H 3/0085; B60H 1/00742; B60H 1/00792; B60H 1/24

(57) ABSTRACT

A method of maintaining safe and breathable air in the interior cabin space of an occupied automobile or vehicle.

### BACKGROUND OF THE INVENTION

Various types of carbon monoxide detectors are known in the prior art. However, what is needed is an air management system that both monitors and can control the interior air quality of an automobile or vehicle. This system can automatically maintain safe breathable air for an automobile or vehicles occupants. This method can both monitor an automobile or vehicles interior air quality, as well as make corrective actions in order to maintain safe breathable air.

### FIELD OF THE INVENTION

The present invention comprises a method for monitoring and maintaining safe breathable air in an automobile or vehicles interior cabin space. This system incorporates air quality sensor(s) being built into the automobile or vehicles interior cabin space; while being hooked up through (to) the automobiles or vehicles computer.

### SUMMARY OF THE INVENTION

The general purpose of the automobile or vehicles interior air quality management system is to save lives. This system is not anticipated, rendered obvious, suggested, or even implied by prior art. Prior art teaches of a standalone automobile carbon monoxide detector which can simply be unplugged or disconnected. Furthermore, prior art in no way teaches of direct communication with the automobile or vehicles computer, but requires occupant participation in order to clear unsafe air.

An automobile or vehicles interior cabin air can be compromised by carbon monoxide penetrating it from the automobile or vehicles exhaust. In order to maintain safe breathable quality air. A carbon monoxide sensor is built into the automobile or vehicles interior cabin space. The sensor continuously senses the air quality while the automobile or vehicles is running. If the sensor(s) detects dangerous levels of carbon monoxide. The sensor(s) sends a signal to the automobile or vehicles computer alerting it to send a visual as well as an audible alert to the automobile or vehicles occupants. Plus, the automobile or vehicles windows will be lowered automatically in order to provide fresh air into the automobile or vehicles interior cabin space. This should reduce the carbon monoxide levels to a safe zone. However, if the interior air quality does not improve and the automobile or vehicle is in park or neutral, or not moving, then the motor (engine) will be automatically shut off. Once the air quality levels return to a safe breathable range; the automobile or vehicle will return to normal operation. This will allow the windows to be closed and the motor (engine) to function properly too.

Every year people die from carbon monoxide while in their automobile or vehicle. It happens often during snow storms when people get stuck. They leave their automobile or vehicle running in order to keep warm. Then when the snow continues to fall it can block the automobile or vehicles exhaust tail pipe. This leads to carbon monoxide build up in the automobile or vehicles interior cabin space. The automobile or vehicles occupants are unknowingly overcome with carbon monoxide which leads to their death.

My method of having air quality sensor(s) built directly into the automobile or vehicles interior cabin space and connected to the automobile or vehicles computer will save lives. Currently an automobile or vehicles computer has many sensors built into it. However, they only monitor the automobile or vehicle for engine run ability and performance. The automobile or vehicles computer currently uses sensors to make instantaneous adjustments to assist with engine (motor) operation, braking, steering and other run ability issues. Using my method to monitor the automobile or vehicles interior cabin space air quality. Consisting of visual and audible ques along with lowering the windows and engine (motor) shut off will be seamless and lifesaving.

### DESCRIPTIONS OF DRAWINGS

FIG. 1A: FIG. 1A shows an outline of an automobile/vehicle.

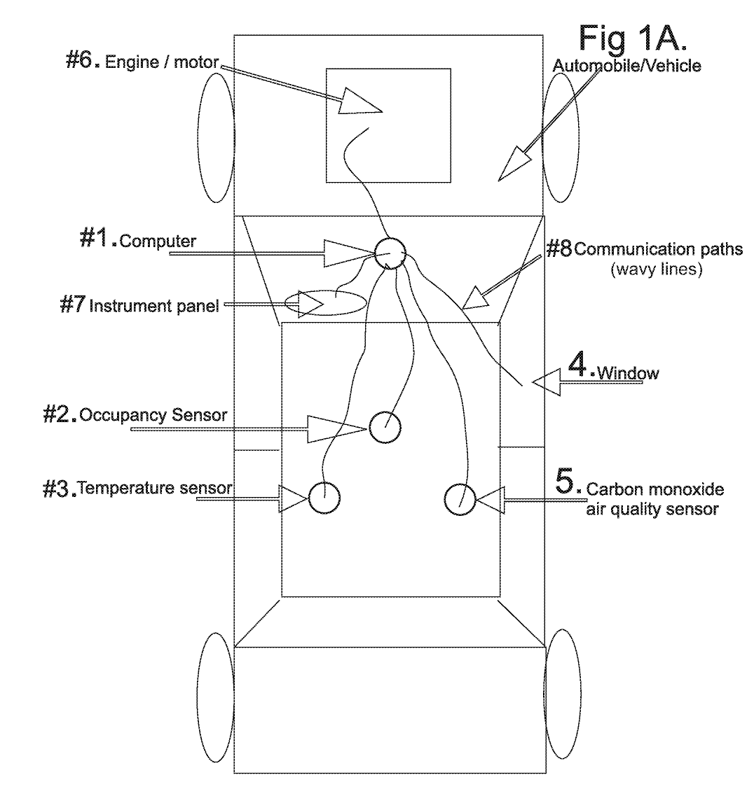

#1 shows the automobile/vehicles computer.

#2 shows the occupancy sensor.

#3 shows the temperature sensor

#4 shows the automobile/vehicles window

#5 shows the carbon monoxide air quality sensor.

#6 shows engine/motor.

#7 shows instrument panel.

#8 shows communication paths through computer.

What is claimed:

1. A method of maintaining safe breathable air in the interior cabin space of an automobile or vehicle. Whereby this system incorporates air temperature, air quality and occupancy sensor(s) being built into the automobile or vehicles interior cabin space; while being hooked up through (to) the automobile or vehicles computer. Thus, allowing computer controlled changes to the automobile or vehicle by the automobile or vehicles computer in order to maintain safe breathable air.

2. A method according to claim one whereby carbon monoxide sensor(s) continuously senses the automobile or vehicles interior cabin space air quality while the automobile or vehicle is occupied as determined by the occupancy sensor(s). If the carbon monoxide sensor(s) detects dangerous levels of carbon monoxide. The sensor(s) sends a signal to the automobile or vehicles computer alerting it to send a visual as well as an audible alert to the automobile or vehicles occupants. The automobile or vehicles windows will also be lowered automatically in order to provide fresh air into the automobile or vehicles interior cabin space. If the interior air quality does not improve to safe levels, then the motor (engine) will be automatically shut off. Once the air quality levels return to a safe breathable range; the automobile or vehicle will return to normal operation.

3. A method according to claim one whereby air temperature sensor(s) are built into the automobile or vehicles interior cabin space. The temperature sensor(s) continuously senses the vehicles or automobiles interior cabin space air temperature while the automobile or vehicle is occupied as determined by the occupancy sensor(s) and not running. If the vehicle or automobiles interior cabin space air temperature reaches unsafe levels while occupancy is sensed by the occupancy sensor(s), the temperature sensor(s) sends a signal to the automobile or vehicles computer alerting it to send a visual as well as an audible alert to the automobile or vehicles occupants. The automobile or vehicles windows will also be lowered automatically in order to provide fresh cooler air into the automobile or vehicles interior cabin space lowering the interior temperatures to safe levels.

4. A method according to claim one whereby occupancy sensor(s) are built into the automobile or vehicles interior cabin space. The sensor(s) continuously senses for occupancy while the automobile or vehicle is running or not.

5. According to claim one computer controlled changes could result in communication to first responders if the automobile or vehicle is a connected car. Thus alerting them as to the location and type of alert.
